(19) United States
(12) Patent Application Publication
(10) Pub. No.: US 2024/0157816 A1
(43) Pub. Date: May 16, 2024

(54) VEHICLE BATTERY TRAY AND METHOD OF MANUFACTURING THE SAME

(71) Applicant: Linamar Structures USA (Alabama) Inc., Guelph (CA)

(72) Inventors: Christoph Stawiarski, Bad Rappenau (DE); Ireneusz Kuboszek, Chybie (PL)

(21) Appl. No.: 18/282,665

(22) PCT Filed: Mar. 16, 2022
(86) PCT No.: PCT/US2022/020591

§ 371 Date: Sep. 18, 2023

Related U.S. Application Data
(60) Provisional application No. 63/162,907, filed on Mar. 18, 2021.

(51) Int. Cl. B60L 50/64; B60L 50/60

(52) U.S. Cl. CPC B60L 50/64; B60L 50/66

(57) ABSTRACT

A vehicle battery tray that, along with a vehicle battery cover, is part of a vehicle battery enclosure that houses and protects a vehicle battery pack. The vehicle battery tray is a modular assembly that uses standardized parts, such as frame components and tray components, and can easily be adapted during manufacturing to fit different size battery packs for different applications and customers. In one example, two or more tray components are joined together to form a battery compartment, whereas in a different example each tray component forms a battery compartment on its own. The frame components may be made from an extruded aluminum-based material, and the tray components may be made from a casted aluminum-based material or a molded plastic material.

### RELATED APPLICATIONS

This application claims the benefit of U.S. Provisional Ser. No. 63/162,907 filed on Mar. 18, 2021, the entire contents of which are incorporated herein by reference.

### FIELD

The present disclosure generally relates to a vehicle battery tray and, more particularly, to a modular vehicle battery tray, such as those used in electrified vehicles (EVs).

### BACKGROUND

A vehicle battery tray constitutes the structural components or elements for most electric vehicle battery systems. It is designed to both provide structural integrity for a battery pack and to seal the battery pack against fluid ingress and, in so doing, a vehicle battery tray must take a number of design considerations into account. For instance, a vehicle battery tray is oftentimes designed to be lightweight in order to help extend the range of the electric vehicle, to be structurally strong to not only support the weight of the battery pack but also to provide strength to the vehicle chassis, and to be sealed so as to prevent water and other contaminants from entering the battery pack, to name a few.

### SUMMARY

According to one aspect, there is provided a vehicle battery tray for an electrified vehicle (EV), comprising: a plurality of frame components; and a plurality of tray components attached to the frame components, wherein the vehicle battery tray is modular.

In accordance with various embodiments, the vehicle battery tray may have any one or more of the following features, either singly or in any technically feasible combination:
at least some of the plurality of frame components are made from an extruded aluminum-based material;
the plurality of frame components include longitudinal frame components that extend along a length of the vehicle battery tray and lateral frame components that extend along a width of the vehicle battery tray, the longitudinal frame components and the lateral frame components are comprised of the same material and have the same cross-sectional configuration and size so that they can be manufactured using the same set of dies and/or tools;
at least one of the longitudinal frame components or the lateral frame components includes a squared off end that is at a right angle to a length of the at least one frame component, at least one of the other of the longitudinal frame components or the lateral frame components includes an interior side surface that is flat, and the squared off end is joined to the interior side surface so that a flush, liquid-tight attachment is established therebetween;
at least some of the plurality of tray components are made from a casted aluminum-based material;
at least some of the plurality of tray components are made from a molded plastic material;
at least some of the plurality of tray components are separate or discrete parts that are comprised of the same material and have the same configuration and size so that they can be manufactured using the same set of dies, molds and/or tools;
at least some of the plurality of tray components include a floor portion and a plurality of wall portions extending upwardly from the floor portion;
the floor portion or at least some of the plurality of wall portions includes a series of raised and/or recessed features that are arranged in a pattern to act as strengthening or stiffening features for the tray component;
at least some of the plurality of wall portions include one or more connecting feature(s) in the form of a flange, the flange is a small edge that is turned at a right angle to a corresponding wall portion and overlaps a flange of an adjacent tray component such that the flanges can be adhered or welded together;
at least some of the plurality of frame components or the plurality of wall portions include a series of openings or apertures, the series of openings or apertures are sized and shaped to allow an item to pass therethrough;
the plurality of tray components include a first tray component and a second tray component, each of the first and second tray components is formed as half of a battery compartment and includes three wall portions extending upwardly from a floor portion and one open side, the first and second tray components are joined together at the open sides to form a combined battery compartment;
the first tray component includes an open side with a connecting feature in the form of an elongated channel and the second tray component includes an open side with a connecting feature in the form of an elongated edge, and the first and second tray components are joined together at the open sides such that the elongated edge is inserted within the elongated channel;
at least some of the plurality of tray components are formed as a full battery compartment that includes four wall portions extending upwardly from a floor portion;
the plurality of frame components are welded to one another and the plurality of tray components are adhered to one another and/or are adhered to the frame components;
the plurality of tray components are adhered to one another and/or are adhered to the frame components with a two-part epoxy or a two-part polyurethane;
at least some of the plurality of frame components have a stiffness enhanced configuration that includes a plurality of interior channels, a majority of the interior channels are, in cross-section, elongated in a horizontal direction such that a longest horizontal dimension A is greater than a longest vertical dimension B;
further comprising one or more cross member(s), the plurality of frame components act as an outer perimeter for the vehicle battery tray and include a plurality of longitudinal frame components, the cross member(s) extend along a width of the vehicle battery tray in between the longitudinal frame components;
further comprising a vehicle battery panel made from an aluminum-based material or steel, the vehicle battery panel is secured to the bottom of the vehicle battery tray;
further comprising one or more support beam(s) inserted between at least some of the plurality of tray components, the support beam(s) have either a webbed cross-sectional configuration or a solid I-beam cross-sectional configuration;
the one or more support beam(s) include a slotted channel at an upper and/or a lower end, the slotted channel receives a flange of one of the tray components.

According to another aspect, there is provided a method of manufacturing a vehicle battery tray, comprising the steps of: extruding and cutting a plurality of frame components; forming a plurality of tray components; assembling the frame components; and attaching the plurality of formed tray components to the plurality of assembled frame components to form the vehicle battery tray, wherein the vehicle battery tray is modular.

In accordance with various embodiments, the method of manufacturing may have any one or more of the following steps, either singly or in any technically feasible combination:
the extruding step further comprises extruding at least some of the plurality of frame components from an aluminum-based material;
the forming step further comprises casting at least some of the plurality of tray components from an aluminum-based material, and the attaching step further comprises attaching the aluminum-based tray components to the plurality of assembled frame components by welding; and
the forming step further comprises molding at least some of the plurality of tray components from a plastic material, and the attaching step further comprises attaching the plastic tray components to the plurality of assembled frame components with adhesive.

### DRAWINGS

Preferred exemplary embodiments will hereinafter be described in conjunction with the appended drawings, wherein like designations denote like elements, and wherein:

FIG. 1 is a perspective view of a vehicle battery assembly installed in an electrified vehicle (EV) chassis;

FIG. 2 is an exploded perspective view of an example of the vehicle battery assembly of FIG. 1;

FIG. 3 is a top view of the vehicle battery tray of FIG. 2;

FIG. 4 is a perspective view of the components of the vehicle battery tray of FIG. 2;

FIG. 5 is a perspective view of the vehicle battery tray of FIG. 2, assembled according to two different embodiments;

FIG. 6 is an enlarged cross-sectional view of a frame component of the vehicle battery tray of FIG. 2, where the frame component has a stiffness enhanced configuration;

FIG. 7 is an enlarged cross-sectional view of a frame component of the vehicle battery tray of FIG. 2, where the frame component has a weight enhanced configuration;

FIG. 8 is an enlarged perspective view of a tray component of the vehicle battery tray of FIG. 2, where the tray component has features on a wall portion;

FIG. 9 is an enlarged perspective view of a tray component of the vehicle battery tray of FIG. 2, where the tray component is joined to an adjacent tray component;

FIG. 10 is a perspective view of two tray components of the vehicle battery tray of FIG. 2 connected together and having an enlarged inset, where the two tray components have connecting features on floor portions;

FIG. 11 is a perspective view of two tray components of the vehicle battery tray of FIG. 2 connected together, where the two tray components have mounting features on floor portions;

FIGS. 12 and 13 are enlarged perspective views of frame and tray components of the vehicle battery tray of FIG. 2, where the frame and tray components have openings on wall portions;

FIG. 14 is an exploded perspective view of another example of the vehicle battery assembly of FIG. 1;

FIG. 15 is a perspective view of the components of the vehicle battery tray of FIG. 14;

FIG. 16 is a perspective view of the vehicle battery tray of FIG. 14, assembled according to two different embodiments;

FIGS. 17 and 18 are perspective views of several tray components of the vehicle battery tray of FIG. 14, where additional support beams according to a first embodiment are inserted between adjacent tray components;

FIGS. 19 and 20 are perspective views of several tray components of the vehicle battery tray of FIG. 14, where additional support beams according to a second embodiment are inserted between adjacent tray components;

FIG. 21 is a perspective view of the vehicle battery tray of FIG. 14, where the top surfaces of the different battery tray components are generally flush with one another;

FIG. 22 is a side view of the vehicle battery tray of FIG. 14, where the top surfaces of the different battery tray components are generally flush with one another;

FIG. 23 is a perspective view of several different sized vehicle battery assemblies installed in different electrified vehicle (EV) chassis;

FIG. 24 is a top view of several different size vehicle battery trays that may be used with different vehicle battery assemblies;

FIGS. 25 and 26 are perspective and top views of several different vehicle battery trays with different combinations of tray components; and

FIG. 27 is a flowchart of a method of manufacturing a vehicle battery tray, such as the ones described herein.

### DESCRIPTION

Electrified vehicles (EVs) typically require large, high output battery packs (e.g., 75 KWh or greater) for propulsion, and such battery packs require battery housings or enclosures to safely secure them within the vehicle. The battery enclosure is attached to and carried by a vehicle chassis and is oftentimes located between the wheels of the vehicle, within the wheelbase. The battery enclosure may include a battery tray, which is a highly engineered component that provides the vehicle with certain structural features and protects the battery pack from fluid ingress and other harmful contaminants, while at the same time being as lightweight as possible in order to extend the range of the vehicle. The vehicle battery tray described herein has a modular design that allows it to be easily adapted or modified to fit different size battery packs for various applications and customers. As used herein, the term “electrified vehicle” or “EV” broadly means any battery electric vehicle (BEV), hybrid electric vehicle (HEV), plug-in hybrid electric vehicle (PHEV), and/or other type of vehicle that uses at least one battery and at least one electric motor for propulsion.

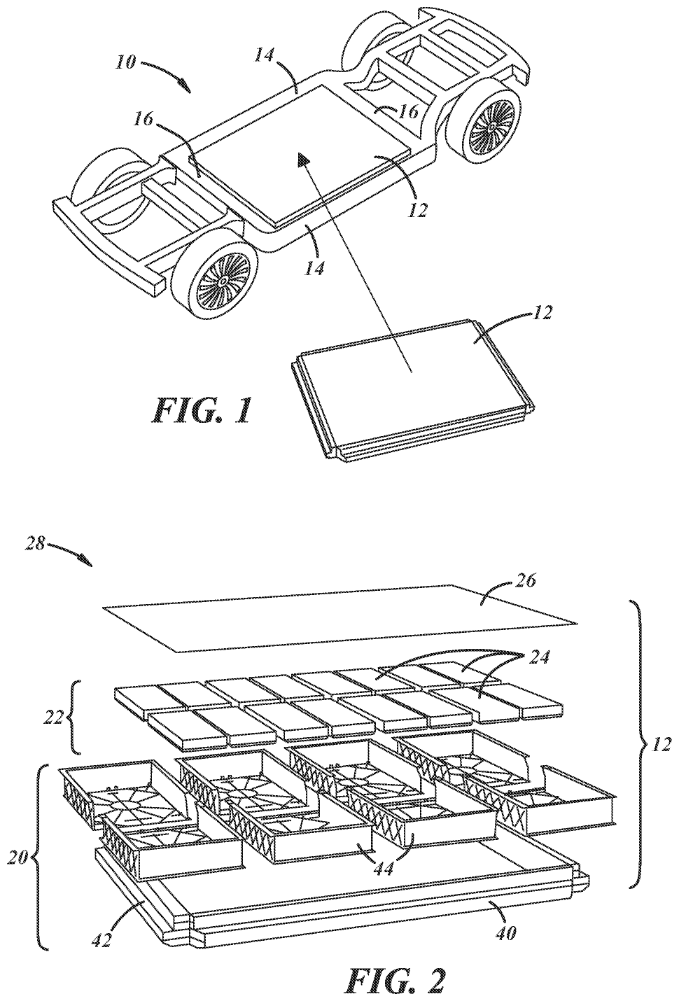

Referring now to FIGS. 1-13, there is shown an example of an electrified vehicle chassis 10 with a vehicle battery assembly 12 installed on the chassis. According to this non-limiting example, the vehicle battery assembly 12 is attached to the vehicle chassis 10 such that it is located between chassis frame rails 14 and chassis cross members 16 and serves as part of the floor or undercarriage of the vehicle, however, other configurations are certainly possible. The vehicle battery assembly 12 can come in a variety of shapes and sizes, depending on the propulsion and other electrical needs of the vehicle, and may include a vehicle battery tray 20, a vehicle battery pack 22 with a number of individual battery cells 24, a vehicle battery cover 26, as well as any combination of suitable vehicle battery electronics and/or other items that are not shown. The vehicle battery pack 22 and corresponding battery cells 24 may be based on lithium-ion, lithium-polymer, lithium-metal, lead-acid, nickel-cadmium, nickel-metal hydride and/or any other suitable battery chemistry known in the art and can be arranged and/or wired according to any number of different configurations. It should be appreciated that the vehicle battery tray 20 disclosed herein is not limited to any particular type of battery chemistry, battery wiring configuration, battery location, battery size, battery shape, battery enclosure, etc., and may be used with any number of different embodiments.

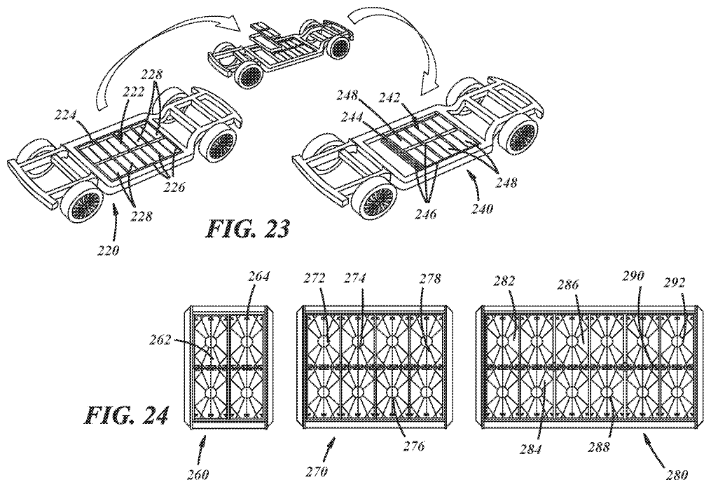

Vehicle battery tray 20, along with the vehicle battery cover 26, is part of a vehicle battery enclosure 28 that houses and protects the vehicle battery pack 22. The vehicle battery tray 20 of the present application is designed to be a modular assembly so that it can be easily adapted during manufacturing to fit different size battery packs for different applications and customers, while at the same time reducing the number of components, the complexity of the manufacturing process and/or the weight of the component. As used herein, in the context of a vehicle battery tray, the term “modular” broadly means a vehicle battery tray that is comprised of standardized parts or building blocks, like frame components and tray components, that can be assembled in different configurations to produce vehicle battery trays of different shapes and sizes. A vehicle battery tray design that is “modular” can be easily modified and assembled in different configurations without requiring substantial changes to the tooling or equipment that manufactures the standardized parts. Illustrations of how a modular vehicle battery tray can be easily adapted to different configurations are shown throughout the present application, including in FIGS. 23-24.

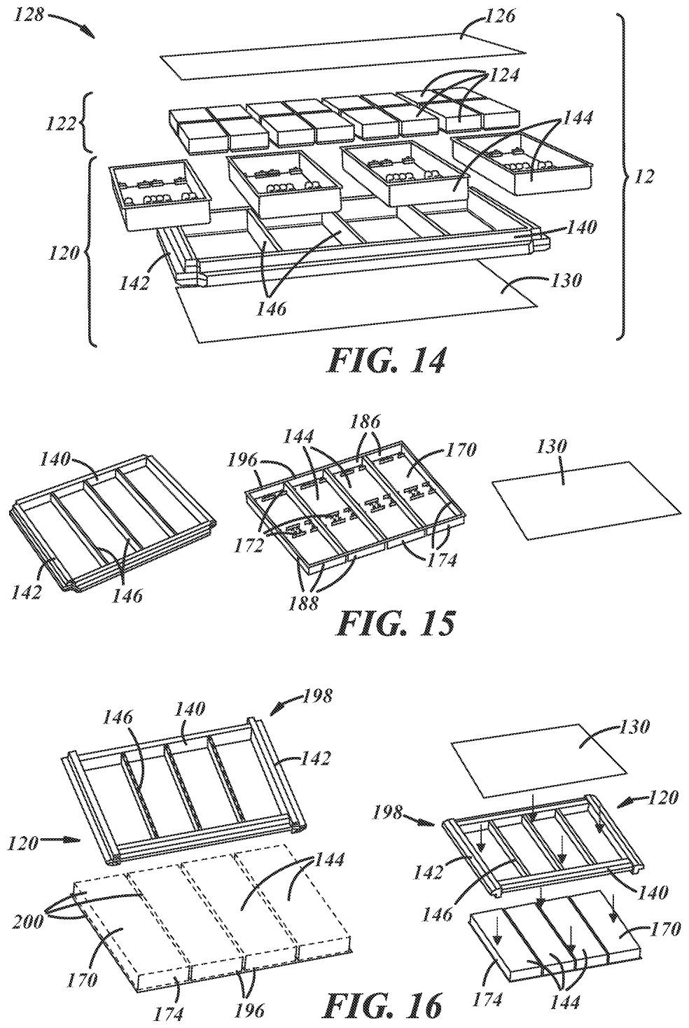

According to the examples shown in FIGS. 2-13, the vehicle battery tray 20 includes a plurality of frame components 40, 42 and a plurality of tray components 44, where two or more tray components may be joined together to form a battery compartment; in the examples illustrated in FIGS. 14-22 on the other hand, a vehicle battery tray 120 has a plurality of frame components 140, 142, 146 and a plurality of tray components 144, and each tray component may form a battery compartment on its own. The vehicle battery tray 20, which is part of the vehicle battery enclosure 28, is a highly engineered component and may be designed to: help protect the vehicle battery pack 22 by acting as a corrosion-resistant and generally liquid-tight enclosure; help improve the operation of the vehicle battery pack 22 by optimizing the thermal environment surrounding the battery cells 24; and/or help protect the passenger compartment in the event of a crash by improving the structural integrity of the vehicle (e.g., by improving the rigidity, stiffness of the chassis), to cite just a few of the possibilities. It is preferable, although not necessary, that the vehicle battery tray 20 provide at least some of the previously listed features, while at the same time: reducing weight, when compared to traditional steel battery enclosures, so that the range of the electrified vehicle can be extended; easing the design process by standardizing certain battery tray components through a more modular design; and/or improving the manufacturing process by reducing the overall number of parts and simplifying the assembly process with a bolt-on design that is easy to integrate with the vehicle chassis.

Frame components 40, 42 act as a perimeter or set of walls for the vehicle battery tray 20 and help secure and fasten the other components of the battery tray together. The frame components 40, 42 are frame pieces that may be extruded or manufactured according to other techniques. Non-limiting examples of suitable materials for the frame components 40, 42 include various aluminum-based materials, such as an Al—Mg—Mn alloy, an Al—Si—Mg alloy, or an eutectic Al—Si alloy (alloys may or may not be heat treated). The vehicle battery tray 20 may be of a rectangular shape such that the longitudinal frame components 40 are longer than the lateral frame components 42, although this is not necessary. It is preferable that all of the frame components, including both longitudinal 40 and lateral 42 frame components, be comprised of the same material and have the same cross-sectional configuration and size. This simplifies the manufacturing process, as only one set of extrusion dies and tools are needed. The longitudinal frame components 40 are shown with squared off or flat ends 50 whose end surfaces are at right angles to the length of the components so that they may be easily and flushly attached to interior side surfaces 52 of the frame members. The lateral frame components 42 are shown with tapered ends 54 whose end surfaces may be angled, rounded, beveled and/or otherwise configured to reduce sharp edges and minimize the possibility of passenger compartment intrusions in a crash. The interior side surfaces 52 may be flat, smooth surfaces to help facilitate the flush, liquid-tight attachment of the longitudinal frame components 40 and/or the sides of the tray components 44 to the surfaces 52, as will be explained, but this is not mandatory. It should be appreciated that while the squared off ends 50 are shown and described as being at the end of the longitudinal frame components 40, they could just as easily be switched so that they are at the end of the lateral frame components 42 instead; in such an arrangement, the lateral frame components 42 with squared off ends would extend between the longitudinal frame components 40 such that they attach to their interior side surfaces 56. Other configurations are certainly possible.

Tray components 44 act as a foundation for the vehicle battery tray 20 and are designed to support and protect the battery cells 24 of the vehicle battery pack 22. The tray components 44 are manufactured as separate or discrete parts and are then joined together in a modular fashion so that various size vehicle battery trays 20 can be assembled by varying the number and/or configuration of tray components, as will be explained. The tray components 44 are tray- or open box-shaped parts that may be made by a casting process, such as aluminum die casting, a molding process, or some other suitable manufacturing process. A non-limiting example of a suitable material for the tray components 44 is an aluminum-based material, such as an Al—Mg—Mn alloy, an Al—Si—Mg alloy, or an eutectic Al—Si alloy (alloys may or may not be heat treated). In the present embodiment, the vehicle battery tray 20 is of a rectangular shape such that a total of eight tray components 44 are arranged to form four battery compartments 82 (in this example, each of the tray components is half of a battery compartment). However, this is not mandatory, as other configurations with different numbers of tray components and/or battery compartments, as well as configurations where each tray component constitutes a full battery compartment, may be used instead. Each of the tray components 44 may include a floor portion 70 with features 72, as well as several wall portions 74 extending upwardly from some of the edges of the floor portion.

Floor portion 70 is the bottom or base of the tray component 44 and is generally flat or planar. As illustrated in the drawings, the floor portion 70 may include a series of raised and/or recessed features 72 that, when arranged in certain patterns, can act as strengthening or stiffening features for the tray component 44 and, hence, the vehicle battery tray 20. According to a different example, the features 72 can be arranged to cooperate with the bottom surface of the vehicle battery pack 22 such that they act as locating or mounting features for the battery cells 24. In the exemplary embodiment, the features 72 are formed in the floor portion 70 when the tray component is being casted or molded and include a circle segment 76 towards the center of the floor portion and a number of linear segments 78 extending out therefrom. The presence of the features 72 and the particular pattern they form is optional and is not limited to any single embodiment (e.g., the floor portion could be smooth with no features 72 or have a different pattern altogether). The bottom or underside surface of the floor portion 70 (not shown) may have a similar or complementary pattern of features 72, it may be smooth without any features 72, or it could have a different arrangement.

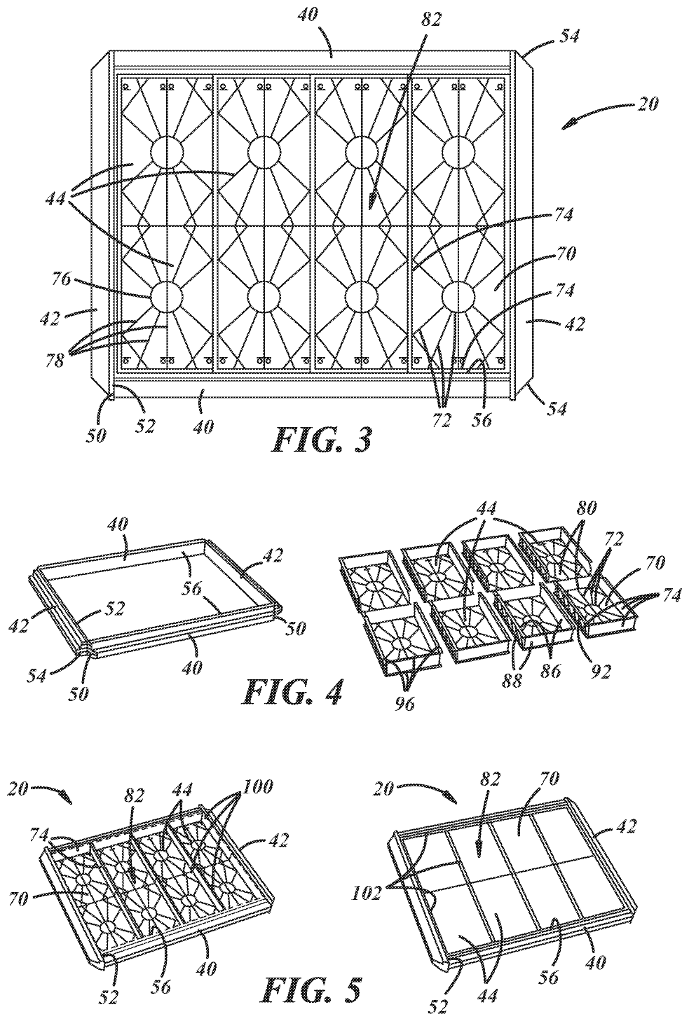

Wall portions 74 are the sides or walls of the tray component 44 and are integrally formed with the floor portion 70 at the edges or perimeter of the floor portion. Each of the tray components 44 may be formed with three of its four sides having wall portions 74 extending upwardly from the floor portion 70. This creates a tray-like structure that is generally bound on three sides with walls, but open on one side 80 so that it can be joined with an adjacent tray component 44 at their open sides 80 to form a larger, combined battery compartment 82 (FIGS. 2 and 4 show adjacent tray components before they are joined at their open sides 80, whereas FIGS. 3 and 5 show adjacent tray components after they are joined to form a combined battery compartment 82). This type of arrangement helps with the modularity of the vehicle battery tray 20, as each tray component 44 is identical or at least similar, and may be useful if the size of the desired battery compartment 82 is too large to easily cast as a single piece (can allow for smaller casting machines). Each of the wall portions 74 has an interior side surface 86 that faces the inside of the tray component 44, and an exterior side surface 88 that faces the exterior side surface of an adjacent tray component or the interior side surface 56, 52 of an adjacent frame component 40, 42.

FIG. 5 shows two different embodiments of an assembled vehicle battery tray 20, where the embodiment on the left has the tray components 44 adhered together and the embodiment on the right (which shows the assembly upside down) has the tray components 44 welded together. In the adhered example on the left, a bead or line of adhesive 100 may be applied along the exterior side surfaces 88 of the tray components 44 so that the different tray components are adhered to one another and/or adhered to the frame components 40,42. The frame components 40, 42, on the other hand, may be welded, adhered and/or otherwise fastened to one another. The height of the wall portions 74 may be selected so that the frame components 40, 42 fit tightly between overhanging flanges 96, which in turn could serve as additional surfaces for adhering the components together. If it is an objective that the vehicle battery tray 20 be liquid-tight in order to protect the vehicle battery pack 22 against liquid ingress (e.g., to satisfy a certain ingress protection rating like IP66), a liquid-tight adhesive that is suitable for bonding to aluminum-based materials, such as a structural adhesive like a structural two-part epoxy or a two-part polyurethane, should be used. In the welded embodiment on the right, the vehicle battery tray 20 is assembled by joining all of the frame components 40, 42 and/or the tray components 44 together with one or more weld joints 102. Metal Inert Gas (MIG) cold metal transfer (CMT) welding may be used to join the various pieces of the vehicle battery tray 20 together, and this process may be carried out with the assembly upside down as shown, but this is not mandatory, as any suitable welding technique for joining aluminum is possible. It may be desirable to augment the weld joint 102 with a liquid-tight sealant in order to further protect the vehicle battery pack 22 from the intrusion of water or contaminants.

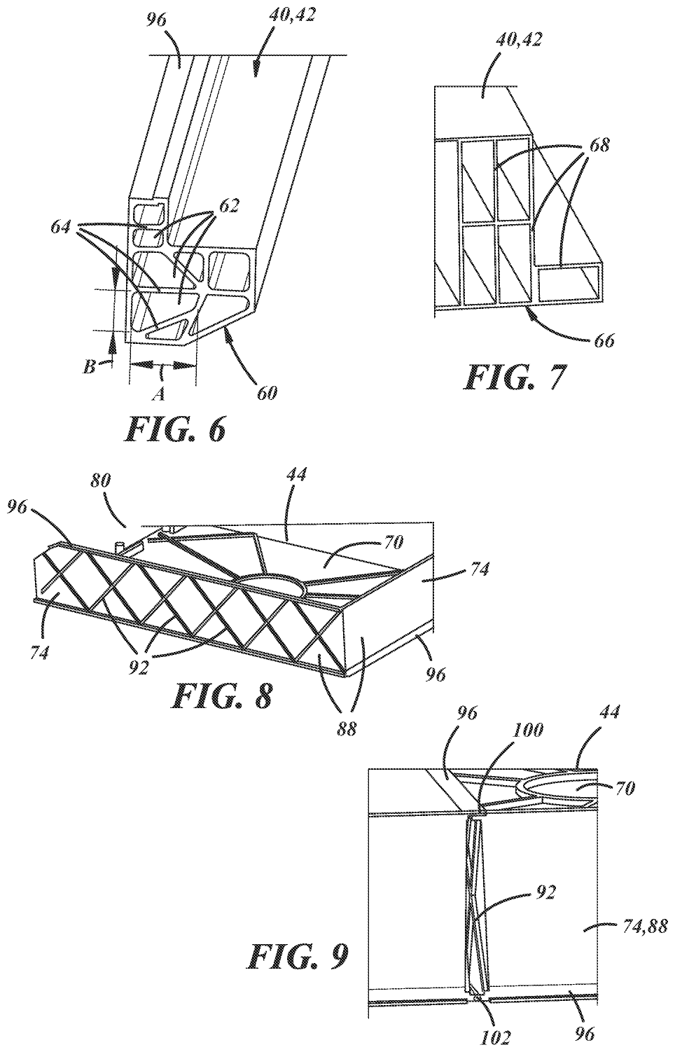

With reference to FIGS. 6 and 7, there are shown two different potential cross-sectional configurations that may be used with the frame components 40, 42. The FIG. 6 example shows a stiffness enhanced configuration 60 for the frame components 40, 42 that includes a number of interior channels or cells 62 that are enhanced or optimized for stiffness or robustness, particularly as it relates to a side impact. In this cross-sectional configuration, a majority of the interior channels 62 are at least somewhat elongated in the horizontal direction (it is not necessary for every interior channel to be horizontally elongated, only a majority), which means that a longest horizontal dimension A of a particular interior channel 62 is greater than a longest vertical dimension B of the same interior channel. Cross-sectional configuration 60 generally increases the stiffness of the frame component 40, 42 and improves the robustness of the vehicle battery tray 20 in terms of resisting a side impact. The stiffness enhanced configuration 60 may also include a larger number of interior channel walls 64 and/or have thicker interior channel walls 64 than other configurations in order to further strengthen the component. The FIG. 7 example, on the other hand, shows a cross-sectional configuration 66 for the frame components 40, 42 that includes a number of interior channel walls 68 that are enhanced for weight reduction. The number of interior channel walls 68 and/or the average thickness of the interior channel walls may be smaller than that of configuration 60 in order to reduce the amount of material and, hence, the overall weight of the component. Other frame component cross-sectional configurations are certainly possible in order to enhance or optimize various characteristics such as stiffness, weight, thermal conductivity, liquid tightness, etc.

According to the illustrated example of FIG. 8, some of the wall portion exterior side surfaces 88 (e.g., those on the sides adjacent to the open side 80) have a series of raised and/or recessed features 92 that, when arranged in certain patterns, can act as strengthening or stiffening features for the tray component 44, and other exterior side surfaces 88 (e.g., those on opposite sides of the open side 80) are smooth and without such features. The presence and/or arrangement of such features 92 may be dictated by the structural integrity needs of the EV chassis and/or the vehicle battery tray 20. In one non-limiting example, the wall portions 74 that are adjacent to the open side 80 have a series of features 92 in the form of interconnected X-shaped ribs that are formed on their exterior side surfaces 88 in order to increase the strength and/or stiffness of the wall portions; of course, other embodiments are possible. The wall portions 74 may also include one or more connecting features 96, which are designed to facilitate attachment of the tray components 44 to other tray components, to the frame components 40, 42 and/or to the vehicle battery cover 26.

In FIG. 9, connecting features 96 in the form of upper and lower flanges are shown extending along the upper and lower edges of the wall portions 74 of the tray components 44. In this example, the features or flanges 96 are small edges, turned at a right angle to the corresponding wall portion 74, such that flanges of adjacent tray components 44 overlap and may be welded, adhered and/or otherwise connected together. It is possible for wall portion 74 to have a connecting feature 96 at an upper edge, a lower edge, or both. According to the example of FIG. 9, connecting features 96 at lower edges of adjacent tray components may be joined with a weld joint 102, such as a MIG CMT weld joint, and connecting features 96 at upper edges of adjacent tray components may be joined with an adhesive joint 100, such as a structural two-part epoxy or a two-part polyurethane adhesive joint. Other arrangements are certainly possible.

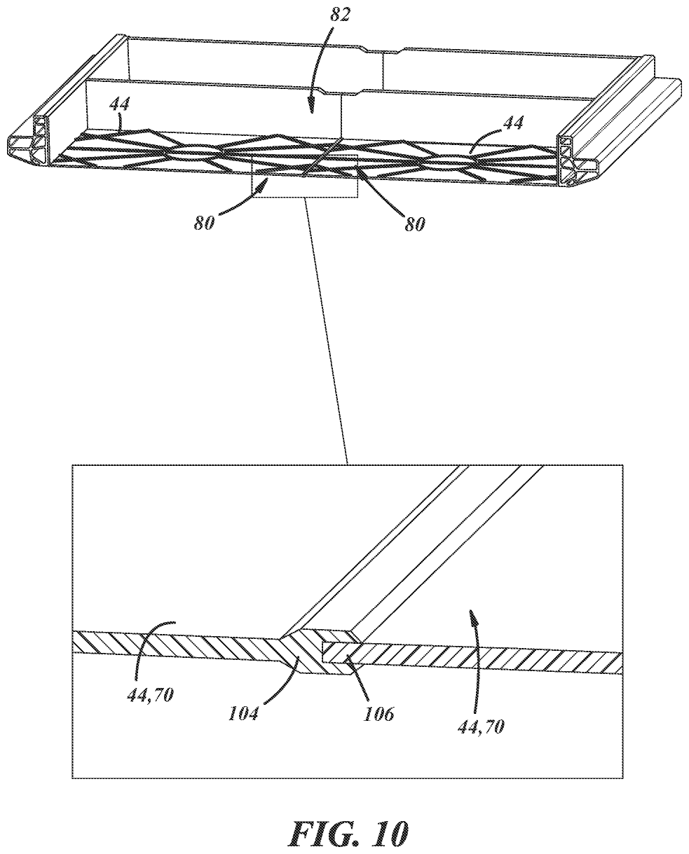

FIG. 10 shows two adjacent tray components 44 connected together to form a combined battery compartment 82, where each of the two tray components has a complementary connecting feature 104, 106 on a floor portion 70 that helps establish a secure and robust connection. Referring to the enlarged inset, the tray component on the left has a connecting feature 104 in the form of an elongated channel that extends along the edge of the tray component that is the open side 80. The size and shape of the elongated channel 104 can vary by application, but it may be an elongated V-shaped or U-shaped channel, as shown, that is able to convey or transmit energy to the adjacent tray component in the event of a collision. The tray component on the right has a connecting feature 106 that is in the form of an elongated edge that is sized and shaped to mate within the elongated channel 104, and is located along an edge of the tray component at the open side 80. To further secure the joint or connection between the tray components 44 and/or make it liquid-tight, an adhesive joint and/or a weld joint may also be used with the connecting features 104, 106. Other forms of connecting features, including ones that use one or more individual tabs and slots, as opposed to elongated channels, may be used instead.

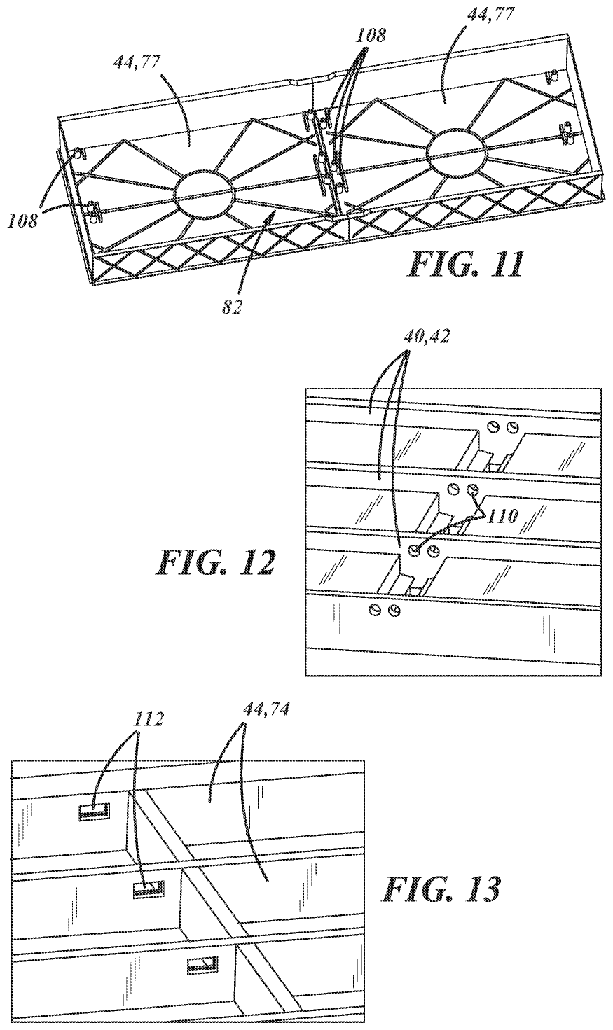

In FIG. 11, two adjacent tray components 44 are connected together to form a battery compartment 82, and each of the tray components includes one or more mounting features 108 located on a floor portion 70. The mounting features 108 may include any suitable combination of features that are designed to either mount the vehicle battery tray 20 to the vehicle chassis 10 or to attach other components or parts to the vehicle battery tray 20. For instance, in the example of FIG. 11, the mounting features 108 include a number of screw bosses or screw domes that are threaded and configured to receive a corresponding screw or bolt the secures the tray component 44, and hence the vehicle battery tray 20, to the vehicle chassis 10. The screw bosses 108 can be located around the perimeter of the floor portion 70 and can be integrally cast or molded into the tray component 44. The mounting features 108 also include a number of reference or locating ribs that assist with the assembly process, as they can provide a guide for installation of the vehicle battery pack 22 into the tray component 44.

FIGS. 12 and 13 show frame and tray components where a series of openings or apertures have been formed to allow different items to pass therethrough. Starting with FIG. 12, several frame components 40, 42 are shown with a series of openings or holes 110 formed in the components. Skilled artisans will appreciate that vehicle battery assemblies can have a large number of different wires, wiring harnesses, cooling lines, pipes and/or other conductors and conduits extending around the assembly, thus, the openings 110 allow for such items to extend from one battery compartment to the next. In FIG. 13, a series of openings or slots 112 are shown that are similar to those in FIG. 12, except openings 112 are formed in wall portions 74 of tray components 44 and are more rectangular in shape. Openings 110, 112 are not limited to being located in any particular component, nor are they limited to a particular size or shape.

Turning now to FIGS. 14-22, there is shown another example of a vehicle battery tray 120 that is similar to the one previously described, except this battery tray has a plurality of tray components that may be molded or otherwise formed as an entire battery compartment, as opposed to being formed as half of a battery compartment and then being joined together. There are advantages to both embodiments: in the previous embodiment, the tray components 44 may be made with smaller, less expensive casting machines or other equipment; in the current embodiment, the overall stiffness or strength of the tray components 144 may be greater, as the entire battery compartment is formed as one integral piece, and the complexity of the assembly process may be simplified since two halves do not need to be subsequently joined together. For purposes of clarity and conciseness, a duplicate description of the embodiments in FIGS. 2-13 has been omitted. Unless stated otherwise, any feature or combination of features described in the previous embodiments applies to the embodiments of FIGS. 14-22 as well, and like reference numerals pertain to like features. According to this non-limiting example, the vehicle battery assembly 12 includes a vehicle battery tray 120, a vehicle battery pack 122 with a number of individual battery cells 124, a vehicle battery cover 126, a vehicle battery panel 130, as well as any combination of suitable vehicle battery electronics and/or other items that are not shown. The vehicle battery tray 120, cover 126 and panel 130 together can make a vehicle battery enclosure 128.

Vehicle battery tray 120 includes a plurality of frame components 140, 142, 146 and a plurality of tray components 144. Frame components 140, 142 act as an outer perimeter or set of walls for the vehicle battery tray 120, in much the same way as frame components 40, 42, whereas cross members 146 provide the battery tray with additional lateral support and integrity. In the previous embodiments the tray components 44 were preferably cast from a metal, such as an aluminum-based material, but in the current embodiments the tray components 144 may be made from injection molded plastics or other synthetic materials. Thus, tray components 144 may not inherently have the same stiffness and strength as their casted counterparts, which is why cross members 146 may be added to the frame to increase its strength, although they are not mandatory. It should be noted that such cross members may be used with the previous embodiments as well. Non-limiting examples of suitable materials for the frame components 140, 142 and/or 146 include various aluminum-based materials, such as an Al—Mg—Mn alloy, an Al—Si—Mg alloy, or an eutectic Al—Si alloy (alloys may or may not be heat treated).

Tray components 144 are designed to support and protect the battery cells 124 of the vehicle battery pack 122, similar to the tray components previously described. The tray components 144 may be injection molded, casted and/or otherwise manufactured as separate or discrete parts and then joined together in a modular fashion so that various size vehicle battery trays 120 can be assembled by varying the number of tray components. Each of the tray components 144 is preferably molded as a single combined battery compartment that extends across the entire width of the vehicle battery tray 120, as illustrated, but it is possible for tray components 144 to be formed as two halves and then joined together at open sides to form a combined battery compartment, as described in the previous embodiment. Tray components 144 are tray- or open box-shaped components that are preferably made of plastic or composite materials, such as polycarbonate (PC) or PC blends or organic hybrid composites (e.g., PA6 TECAMID with about 60% glass fiber, organic hybrid composite with a fiber reinforced sheet blank impregnated with nylon base and over-molded with nylon-based plastic). In the example where tray components 144 are plastic or composite materials, they can be made by injection molding or glass mat thermoplastic (GMT) molding. It should be appreciated that the vehicle battery tray is not limited to the previous examples of materials and manufacturing methods, as other examples are certainly possible (e.g., it is possible for tray components 144 to be made from metals, such as aluminum-based materials, that are casted, as previously explained). Each of the tray components 144 may include a floor portion 170 with features 172, as well as several wall portions 174 extending upwardly from the outer edges of the floor portion.

Floor portion 170 is the bottom or base of the tray component 144 and is generally flat or planar. The floor portion 170 may include a series of raised and/or recessed features 172 that, when arranged in certain patterns, can act as strengthening or stiffening features and/or can act as locating features for properly assembling the battery cells 124 in the tray components 144. In the example shown in FIG. 15, features 172 are located at each lateral end of the floor portion 170, as well as towards the middle or center of the floor portion. The bottom or underside surface of the floor portion 170 (shown in FIG. 16) may have a similar or complementary pattern of features 172, it may be smooth without any features 172, or it could have a different arrangement.

Wall portions 174 are the sides or walls of the tray component 144 and are integrally formed with the floor portion 170 at its edges or perimeter. Each tray component 144 may be formed with all four sides having wall portions 174 extending upwardly from the floor portion 170 to create a tray-like structure that is generally bound on all four sides with walls. Each of the wall portions 174 has an interior side surface 186 that faces the inside of the tray component 144, and an exterior side surface 188 that faces the interior side surface of an adjacent frame component 140, 142, 146. The wall portions 174 may also include one or more connecting features 196, which are designed to facilitate attachment of the tray components 144 to the frame components 140, 142, 146, to the vehicle battery cover 126 and/or to the vehicle battery panel 130. Connecting features 196 in the form of a flange is shown extending along the upper edge of each of the wall portion exterior side surfaces 188. In this example, the flanges 196 are small edges, turned at a right angle to the corresponding wall portion 174, such that they may be welded, adhered and/or otherwise connected to frame components 140, 142, 146 and/or the vehicle battery cover 130, as will be explained. A lower flange, not shown, may be added to the lower edge of the wall portion exterior side surface 188 to facilitate attachment to the vehicle battery panel 130.

With reference to FIG. 16, there is shown an embodiment of a vehicle battery tray 120 being assembled, where the frame components can be welded together and the tray components can be adhered in place. Once the frame components 140, 142 and cross members 146 are welded and/or otherwise joined together to a form a grid-like frame structure 198, the various tray components 144 can be adhered to the frame structure with a bead or line of adhesive 200. A dense, liquid-tight adhesive that is suitable for bonding to aluminum-based materials and plastic materials, such as a structural two-part epoxy or a two-part polyurethane, may be used. Depending on the requirements of the application, a vehicle battery panel 130 made of an aluminum- or steel-based material may be secured to the bottom of the assembly, such as by welding it to the bottom of the frame structure 198. The vehicle panel assembly 130 can provide the vehicle battery enclosure 128 with added stiffness and underside protection, which may be needed if the battery enclosure is to be integrated with the vehicle undercarriage and/or exposed to the outside environment.

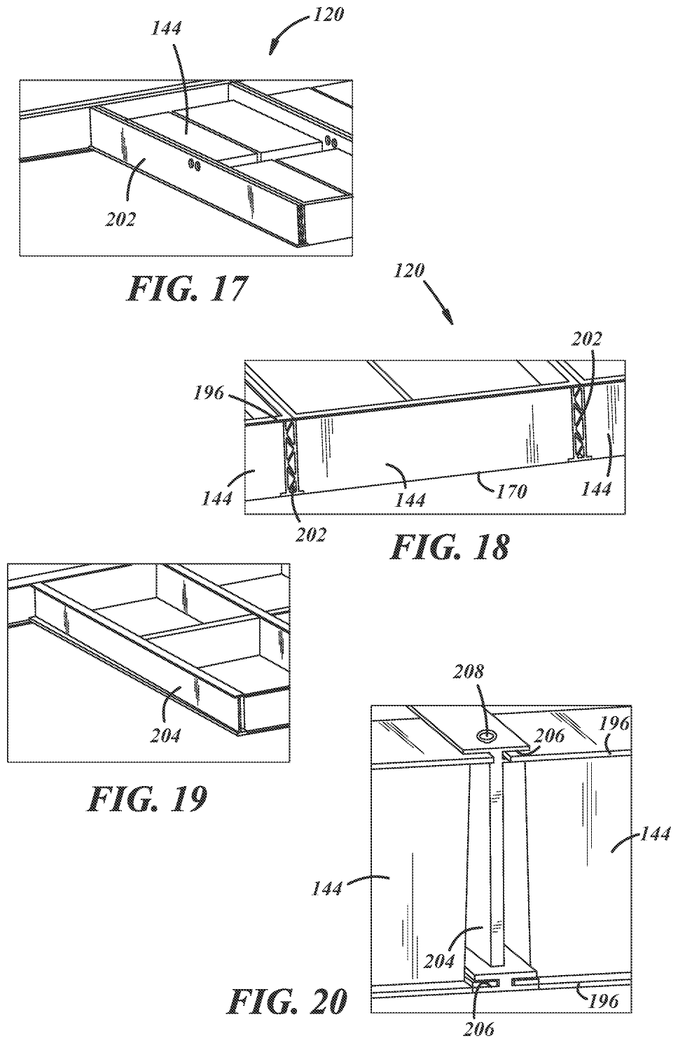

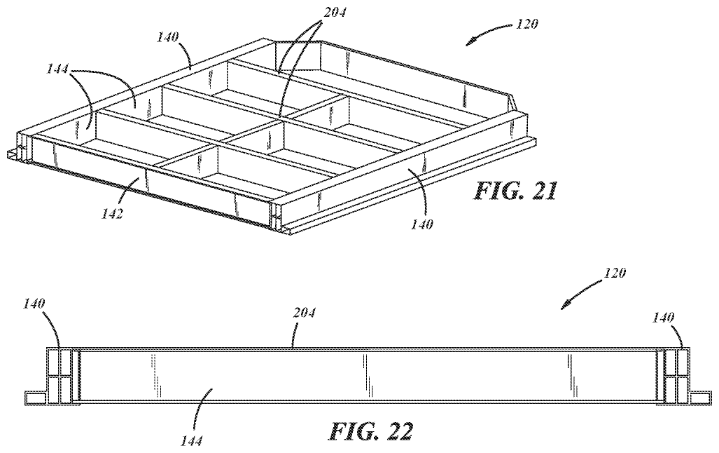

FIGS. 17-22 illustrate some optional features which may be used to further stiffen, strengthen, support and/or otherwise enhance the vehicle battery tray. Although FIGS. 17-22 are described in the context of the present embodiments, it should be appreciated that these features may be used with the embodiments of FIGS. 1-13 as well, particularly if those embodiments include tray components that are plastic. One or more additional frame components in the form of support beams 202 may be added to the vehicle battery tray 120, such as between adjacent tray components 144, in order to increase the stiffness and strength of the battery tray, particularly as it relates to side impacts. The support beams 202 may be extruded or otherwise made from a suitably strong metal, such as an Al—Mg—Mn alloy, an Al—Si—Mg alloy, or an eutectic Al—Si alloy (alloys may or may not be heat treated). According to the example in FIGS. 17-18, a support beam 202 with a webbed cross-sectional configuration is inserted at each of the junctions between adjacent tray components 144 and is secured in place with adhesive, such as a structural two-part epoxy or a two-part polyurethane. The bottom surface of the support beam 202 may be flush with the bottom surface of the floor portion 170, so as to facilitate easy attachment of the vehicle battery panel 130. Similarly, the upper surface of the support beam 202 may fit underneath the underside of flange 196 so that the vehicle battery cover 126 can be easily and flushly attached to the vehicle battery tray 120 at the series of flanges or connecting features 196. According to the example in FIGS. 19-20, a support beam 204 with a solid I-beam type cross-sectional configuration is inserted at each of the junctions between adjacent tray components 144 and is secured in place with adhesive, such as a structural two-part epoxy or a two-part polyurethane. The support beam 204 may include one or more slotted channels 206 at the upper and/or lower ends of the support beam that extend the length of the support beam and are designed to mate with one or more flanges or other components of the tray components 144. The upper and/or lower surfaces of the support beams 204 may be flush with the upper and/or lower surfaces of flanges 196, respectively, for easy attachment of other components. It is also possible for the support beam 204 to have one or more threaded holes 208 formed into the sides or ends of the support beam so as to accommodate attachment to another component. FIGS. 21-22 demonstrate a vehicle battery tray 120 with such a configuration; it is worth noting, the flushness or flatness of the upper surfaces of the frame components 140, 142, the tray components 144, and the support beams 204 so that a vehicle battery cover 126 can be flushly secured thereto.

Turning now to FIGS. 23 and 24, there are shown some illustrations that explain the modularity and adaptability of the vehicle battery tray described herein. Skilled artisans will appreciate that due to the rapid development in electrified vehicles (EVs) of all sizes and types, there is a consistently changing set of needs and demands concerning vehicle battery packs and, hence, vehicle battery trays. For instance, a large size or heavy EV 220 (e.g., a commercial delivery vehicle, a full size pickup truck, or a full size sports utility vehicle) may require a large vehicle battery pack 222 to accommodate its propulsion and/or other electrical needs. In such a case, a vehicle battery tray 224 could be provided with frame components 226 and four battery compartments 228. If a different customer was manufacturing a medium size EV 240 (e.g., a cross over vehicle, a full size sedan, etc.), then a medium sized vehicle battery pack 242 accommodated in a medium sized vehicle battery tray 244 may be required. In this case, the medium sized vehicle battery tray 244 could be designed simply by shortening the length of some of the frame components 246 and reducing the number of battery compartments 248 from four to three, but the same tray components could be used. The vehicle battery tray is comprised of just several “building blocks,” like the frame components and the tray components, and is therefore modular so that it can be easily modified and arranged in various configurations to accommodate different vehicle battery needs without requiring substantial changes to tooling, equipment, etc. FIG. 24 shows three different sized vehicle battery trays: a small battery tray 260 with two battery compartments 262, 264; a medium battery tray 270 with four battery compartments 272, 274, 276, 278; and a large battery tray 280 with six battery compartments 282, 284, 286, 288, 290, 292. For these embodiments, each of the tray components can be formed as two separate halves that are joined together to make a combined battery compartment (e.g., by casting or molding) or each of the tray components can be formed as a single tray component in the form of a combined battery compartment (e.g., by casting or molding).

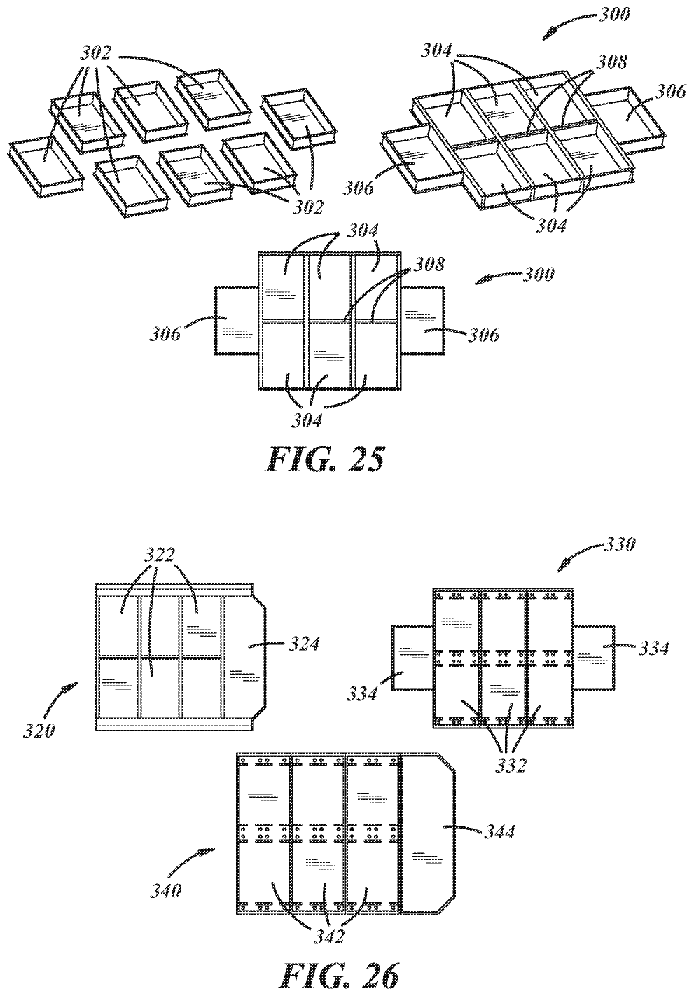

In FIG. 25, there is shown another possible arrangement for a vehicle battery tray 300 to demonstrate its modular flexibility. In this arrangement, the vehicle battery tray 300 includes a number of smaller tray components 302 that are configured to provide six main battery compartments 304 and two side battery compartments 306. The tray components 302 may be cast out of metal, they may be molded from plastic or composite materials, or they may be made according to some other suitable method. The vehicle battery tray 300 may be assembled without frame components, or frame components 308 may be added to increase the stiffness or strength of the assembly. It should be recognized that any number of potential combinations of tray components, including various combinations and arrangements of tray component embodiments previously described, may be put together to suit the particular needs of a vehicle battery assembly.

The embodiments shown in FIG. 26 include different embodiments of vehicle battery trays, where different tray components have been mixed and matched to arrive at a particular configuration. For instance, vehicle battery tray 320 uses a combination of smaller tray components 322 (similar to those of FIG. 25) with a front casting component 324 that may be designed to hold certain vehicle battery assembly components at a front of the assembly. Vehicle battery tray 330 has a combination of larger tray components 332 formed as single combined battery compartments (similar to those of FIG. 14) in combination with smaller tray components 334 that act as side battery compartments. Vehicle battery tray 340 includes larger tray components 342 with a front casting component 344 attached near the front of the assembly. Of course, numerous other embodiments, arrangements, combinations, etc. are possible and are included within the scope of this application.

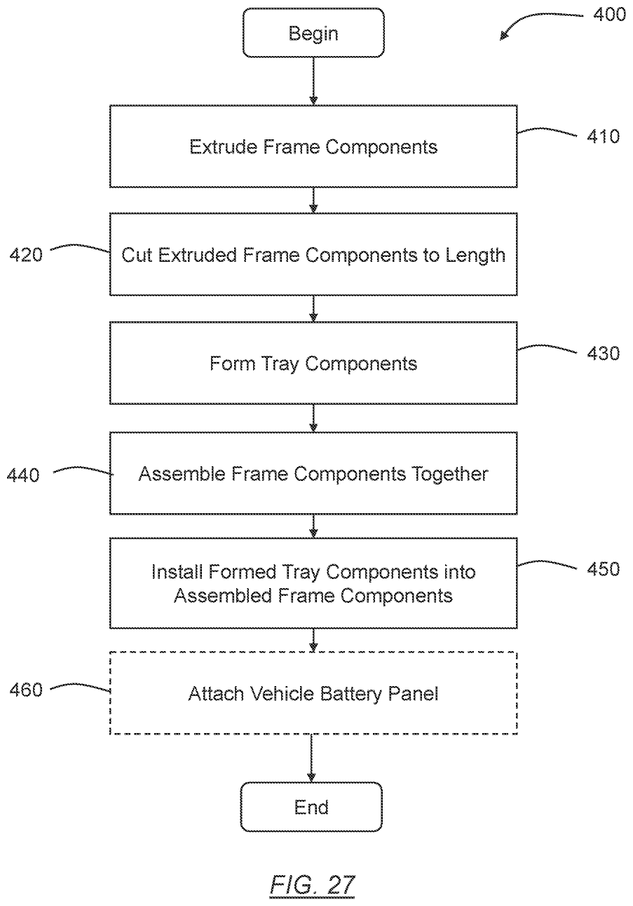

FIG. 27 is a flowchart that describes one possible method 400 of manufacturing the vehicle battery trays described in the present application. Starting with step 410, one or more frame components, such as frame components 40, 42, 140, 142, are extruded. Any suitable method may be used to produce the frame components, including various aluminum extruding methods.

Next, the extruded frame components are cut to length, step 420. In one embodiment, the frame components are cut to the desired length(s) by using a cutting or shearing tool in conjunction with the extruding tool so that the extrusions are “to length” as they leave the extrusion process. In a different embodiment, the frame components are formed in long extruded strips that are later cut or sheared to the length(s) that are needed. Any suitable method may be used to cut the frame components, including methods that use cutting or shearing knives or tools, abrasive tools, water jet cutting tools, laser cutting tools, etc.

In step 430, the tray components are formed by one of several different embodiments. According to a first embodiment, each of the tray components is cast or molded as half of a battery compartment with three wall portions and one open side (see, for example, FIG. 2). According to a second embodiment, each of the tray components is cast or molded as a full or combined battery compartment (see, for example, FIGS. 14, 25) with four wall portions and no open sides. Each of the preceding embodiments may involve casting an aluminum-based material or molding a plastic or composite material, although this is not required. Other embodiments and techniques for forming the tray components may certainly be employed.

The frame components are then assembled or connected together, step 440. In the case of casted tray components that require no additional cross members, the frame components may be welded to form a square or rectangular shape that is of the required size (see FIG. 4). If tray components are being used that require cross members for additional lateral strength and support, then the frame components, including cross members, can be welded to form a grid-like structure (see FIG. 15). Any suitable, known technique for welding or otherwise attaching aluminum-based frame components may be used.

Next, the formed tray components are installed in the assembled frame components, step 450. This step may be carried out according to several potential embodiments. In an adhesive embodiment, the formed tray components, whether they be cast from an aluminum-based material or molded from a plastic material, are adhered into the assembled frame components. Adhesive may be applied only around the outer perimeter of the group of tray components or it may also be applied around the outer perimeter of each of the tray components and/or cross members. In a welding embodiment, which would be suitable for use with casted tray components that are made from metal, each of the tray components may be welded all along their perimeters and may even be welded in between the tray component halves that make up a combined tray component to help ensure a liquid-tight seam.

In step 460, which is an optional step, a vehicle battery panel is attached to the underside of the vehicle battery tray. For those embodiments, such as that shown in FIG. 2, that do not include a vehicle battery panel, this step could simply be omitted. If a vehicle battery panel is to be installed on the underside to further protect the vehicle battery pack, then it may be welded to the frame components, such as around the perimeter of the frame components and/or along the cross members.

After method 400 is complete, the other components of the vehicle battery assembly 12 may be installed or assembled. For example, the battery cells 24 may be installed within the vehicle battery tray 20 and the vehicle battery cover 26 may be attached and sealed to the vehicle battery tray. Other assembly or post-assembly steps may be performed as well.

It should be appreciated that the present method may include a different combination and/or sequence of steps than those shown in FIG. 27 and described herein, as the present method is not so limited. Furthermore, any number of additional processing steps may be included to provide access holes for wiring, to improve the thermal properties of the vehicle battery tray (e.g., by adding a separate heating or cooling plate), to make the vehicle battery tray liquid tight, to adapt the vehicle battery tray for bolt-on or other easy assembly to the EV frame, etc.

It is to be understood that the foregoing description is not a definition of the invention, but is a description of one or more exemplary illustrations of the invention. The invention is not limited to the particular example(s) disclosed herein, but rather is defined solely by the claims below. Furthermore, the statements contained in the foregoing description relate to particular exemplary illustrations and are not to be construed as limitations on the scope of the invention or on the definition of terms used in the claims, except where a term or phrase is expressly defined above. Various other examples and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

1. A vehicle battery tray for an electrified vehicle (EV), comprising:
a plurality of frame components; and
a plurality of tray components attached to the frame components,
wherein the vehicle battery tray is modular.

2. The vehicle battery tray of claim 1, wherein at least some of the plurality of frame components are made from an extruded aluminum-based material.

3. The vehicle battery tray of claim 1, wherein the plurality of frame components include longitudinal frame components that extend along a length of the vehicle battery tray and lateral frame components that extend along a width of the vehicle battery tray, the longitudinal frame components and the lateral frame components are comprised of the same material and have the same cross-sectional configuration and size so that they can be manufactured using the same set of dies and/or tools.

4. The vehicle battery tray of claim 3, wherein at least one of the longitudinal frame components or the lateral frame components includes a squared off end that is at a right angle to a length of the at least one frame component, at least one of the other of the longitudinal frame components or the lateral frame components includes an interior side surface that is flat, and the squared off end is joined to the interior side surface so that a flush, liquid-tight attachment is established therebetween.

5. The vehicle battery tray of claim 1, wherein at least some of the plurality of tray components are made from a casted aluminum-based material.

6. The vehicle battery tray of claim 1, wherein at least some of the plurality of tray components are made from a molded plastic material.

7. The vehicle battery tray of claim 1, wherein at least some of the plurality of tray components are separate or discrete parts that are comprised of the same material and have the same configuration and size so that they can be manufactured using the same set of dies, molds and/or tools.

8. The vehicle battery tray of claim 1, wherein at least some of the plurality of tray components include a floor portion and a plurality of wall portions extending upwardly from the floor portion.

9. The vehicle battery tray of claim 8, wherein the floor portion or at least some of the plurality of wall portions includes a series of raised and/or recessed features that are arranged in a pattern to act as strengthening or stiffening features for the tray component.

10. The vehicle battery tray of claim 8, wherein at least some of the plurality of wall portions include one or more connecting feature(s) in the form of a flange, the flange is a small edge that is turned at a right angle to a corresponding wall portion and overlaps a flange of an adjacent tray component such that the flanges can be adhered or welded together.

11. The vehicle battery tray of claim 8, wherein at least some of the plurality of frame components or the plurality of wall portions include a series of openings or apertures, the series of openings or apertures are sized and shaped to allow an item to pass therethrough.

12. The vehicle battery tray of claim 1, wherein the plurality of tray components include a first tray component and a second tray component, each of the first and second tray components is formed as half of a battery compartment and includes three wall portions extending upwardly from a floor portion and one open side, the first and second tray components are joined together at the open sides to form a combined battery compartment.

13. The vehicle battery tray of claim 12, wherein the first tray component includes an open side with a connecting feature in the form of an elongated channel and the second tray component includes an open side with a connecting feature in the form of an elongated edge, and the first and second tray components are joined together at the open sides such that the elongated edge is inserted within the elongated channel.

14. The vehicle battery tray of claim 1, wherein at least some of the plurality of tray components are formed as a full battery compartment that includes four wall portions extending upwardly from a floor portion.

15. The vehicle battery tray of claim 1, wherein the plurality of frame components are welded to one another and the plurality of tray components are adhered to one another and/or are adhered to the frame components.

16. The vehicle battery tray of claim 15, wherein the plurality of tray components are adhered to one another and/or are adhered to the frame components with a two-part epoxy or a two-part polyurethane.

17. The vehicle battery tray of claim 1, wherein at least some of the plurality of frame components have a stiffness enhanced configuration that includes a plurality of interior channels, a majority of the interior channels are, in cross-section, elongated in a horizontal direction such that a longest horizontal dimension A is greater than a longest vertical dimension B.

18. The vehicle battery tray of claim 1, further comprising one or more cross member(s), the plurality of frame components act as an outer perimeter for the vehicle battery tray and include a plurality of longitudinal frame components, the cross member(s) extend along a width of the vehicle battery tray in between the longitudinal frame components.

19. The vehicle battery tray of claim 1, further comprising a vehicle battery panel made from an aluminum-based material or steel, the vehicle battery panel is secured to the bottom of the vehicle battery tray.

20. The vehicle battery tray of claim 1, further comprising one or more support beam(s) inserted between at least some of the plurality of tray components, the support beam(s) have either a webbed cross-sectional configuration or a solid I-beam cross-sectional configuration.

21. The vehicle battery tray of claim 20, wherein the one or more support beam(s) include a slotted channel at an upper and/or a lower end, the slotted channel receives a flange of one of the tray components.

22. A method of manufacturing a vehicle battery tray, comprising the steps of:
extruding and cutting a plurality of frame components;
forming a plurality of tray components;
assembling the frame components; and
attaching the plurality of formed tray components to the plurality of assembled frame components to form the vehicle battery tray, wherein the vehicle battery tray is modular.

23. The method of claim 22, wherein the extruding step further comprises extruding at least some of the plurality of frame components from an aluminum-based material.

24. The method of claim 22, wherein the forming step further comprises casting at least some of the plurality of tray components from an aluminum-based material, and the attaching step further comprises attaching the aluminum-based tray components to the plurality of assembled frame components by welding.

25. The method of claim 22, wherein the forming step further comprises molding at least some of the plurality of tray components from a plastic material, and the attaching step further comprises attaching the plastic tray components to the plurality of assembled frame components with adhesive.
